(19) United States
(12) Patent Application Publication
(10) Pub. No.: US 2010/0088070 A1
(43) Pub. Date: Apr. 8, 2010

(54) FILE-CONVERTING METHOD AND APPLICATION THEREOF

(76) Inventors: Shih-Chi Wang, Taipei City (TW); Chun-Ying Yang, Taipei City (TW); Ting-Chang Lin, Taipei City (TW); Quie-Wau Chen, Taipei City (TW)

Correspondence Address: BRIAN M. MCINNIS, 12th Floor, Ruttonjee House, 11 Duddell Street, Hong Kong, HK

(21) Appl. No.: 12/325,765

(22) Filed: Dec. 1, 2008

(30) Foreign Application Priority Data
Oct. 6, 2008 (TW) 97138423

(51) Int. Cl. G06F 17/50; G06F 7/00; G06F 17/30; G06F 7/06

(52) U.S. Cl. 703/1; 707/E17.006; 707/E17.014

(57) ABSTRACT

A file-converting method is disclosed. The file-converting method includes the following steps. Obtain an architecture file from Mechanical Computer-aided Design (MCAD) software. Analyze the architecture file to obtain at least an architecture element, which is not compatible with Electrical Computer-aided Design (ECAD) software, according to a converting database. Replace the architecture element in the architecture file with a symbol element, which is compatible with the ECAD software, to generate a layout file.

### RELATED APPLICATIONS

This application claims priority to Taiwan Application Serial Number 97138423, filed Oct. 6, 2008, which is herein incorporated by reference.

### FIELD OF THE INVENTION

The present invention relates to an aided design method and application thereof, and more particularly to a computer-aided design method and application thereof.

### DESCRIPTION OF PRIOR ART

In the manufacturing process of products, it is necessary to subject the products to both layout designs and mechanical designs at the beginning. The layout design allocates wiring for the electronic components of the products, while the mechanical design satisfies the mechanical requirements of the products. However, the requirements necessitated in the mechanical design can result in limitations to the layout design. For example, a circuit board of a product may need to be drilled with holes due to requirements necessitated in the mechanical design. Consequently, wiring or electronic components cannot be allocated to the regions of the circuit board during the layout design.

Conventionally, files outputted from Mechanical Computer-Aided Design (MCAD) software and Electrical Computer-Aided Design (ECAD) software are integrated as one single format (such as IDF 3.0), so that the files respectively produced by using the MCAD software and the ECAD software are compatible with one another. However, the ECAD software is still unable to recognize some of the architecture elements. For instance, when the ECAD software is used to design a product, it is only able to define shapes and sizes of a circuit board, and utilize only the electronic components that have been defined on the circuit board. As a result, the ECAD software cannot recognize the architecture elements defined by using shapes and sizes thereof, which prevents these types of architecture elements from being listed for consideration in the process of layout design.

Therefore, a file-converting method and application thereof is needed, so as to allow the architecture elements to be recognized by the ECAD software.

### SUMMARY OF THE INVENTION

A primary technical solution proposed in the invention is a file-converting method and application thereof, which is used to replace architecture elements with symbol elements that can be recognized by ECAD software when architecture files are converted into layout files. Consequently, the ECAD software can list the recognized architecture elements for consideration during the process of layout design.

According to an embodiment of the invention, a file-converting method includes following steps:

(1) Obtaining an architecture file from MCAD software.

(2) Analyzing the architecture file to obtain at least an architecture element incompatible with ECAD software, according to a converting database.

(3) Replacing the architecture element in the architecture file with a symbol element compatible with the ECAD software, to generate a layout file.

Another embodiment of the invention proposes a file-converting system, which includes an architecture obtainer, a file analyzer, and an element replacer. The architecture obtainer is used to obtain an architecture file from the MCAD software. The file analyzer is used to analyze the architecture file, so as to obtain at least an architecture element incompatible with the ECAD software. The element replacer is used to replace the architecture element in the architecture file with a symbol element compatible with the ECAD software, to generate a layout file.

### BRIEF DESCRIPTION OF DRAWINGS

The aforesaid objectives, characteristics, advantages and embodiments of the present invention will be more clearly understood when considered in conjunction with the accompanying drawings, in which:

FIG. 1 is a flow chart showing a file-converting method according to an embodiment of the invention.

FIG. 2 is a schematic view showing an embodiment of analyzing the architecture file (Step 104) of FIG. 1 according to the invention.

FIG. 3 is a block view showing functions of a file-converting system according to another embodiment of the invention.

### DETAILED DESCRIPTION OF PREFERRED EMBODIMENTS

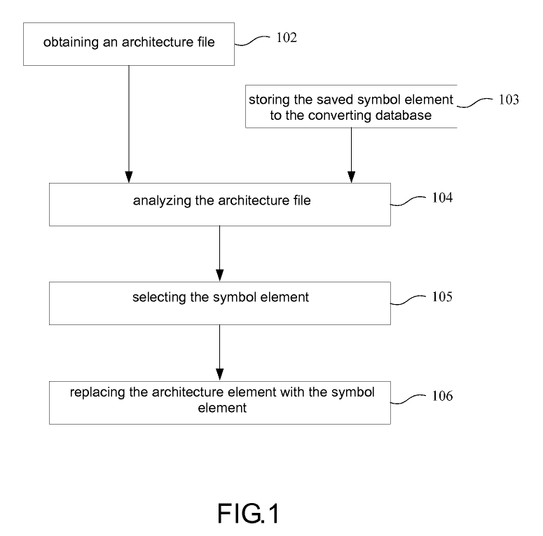

Referring to FIG. 1, which is a flow chart showing a file-converting method according to an embodiment of the invention. When the file-converting method is used to convert architecture files into layout files, it can replace architecture elements not recognizable by ECAD software as symbol elements recognizable by the ECAD software. The file-converting method includes:

(1) Obtaining an architecture file from MCAD software (Step 102).

(2) Analyzing the architecture file to obtain at least an architecture element incompatible with ECAD software, according to a converting database (Step 104).

(3) Replacing the architecture element in the architecture file with a symbol element compatible with the ECAD software, to generate a layout file (Step 106).

The MCAD software may be Pro-E or other types of MCAD software, whereas the ECAD software may be Allegro or other types of ECAD software. The architecture element can be a block, or other elements that cannot be recognized by the ECAD software. For instance, the architecture element can be a drill hole element. In other words, the architecture element is a block intended for drilling holes originally. In addition, the architecture element can also be a keepout element. The keepout element is intended for disposing or adhering other architecture elements thereto. In this embodiment of the invention, the architecture file and the layout file can be IDF 3.0, or other file formats that are compatible with the MCAD software and the ECAD software.

Moreover, the step 106 may be further included of a process of converting elements of the architecture file that are compatible with the ECAD software into element formats used by the ECAD software. Consequently, the file-converting method can be used to allow all of the elements of the layout file to be recognized by the ECAD software.

The file-converting method can be used to establish a converting database in prior to analyzing the architecture file. Thus the file-converting method includes:

(1.1) Storing at least a saved symbol element to the converting database (Step 103).

The saved symbol element is compatible with the ECAD software, and is used to replace a saved architecture element incompatible with the ECAD software. Therefore, the file-converting method can store the saved symbol element to the converting database, such that an architecture element can be obtained from the converting database during the analysis of the architecture file.

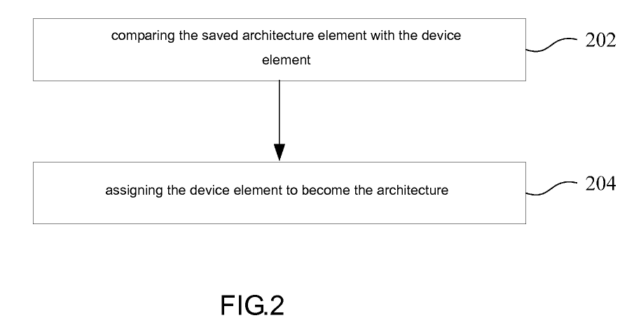

FIG. 2 shows an embodiment of analyzing the architecture file (Step 104) of FIG. 1 according to the invention. The step of analyzing the architecture file (Step 104) actually obtains the architecture element by carrying out comparison with the saved architecture element in the converting database. The step (Step 104) of analyzing the architecture file includes:

(2.1) Comparing the saved architecture element with at least a device element of the architecture file (Step 202).

(2.2) Assigning the device element to become the architecture element when the saved architecture element matches with the device element (Step 204).

As a result, the file-converting method can be used to obtain the architecture element from the architecture file.

Referring to FIG. 1, the file-converting method can obtain the symbol element from the converting database prior to replacing the architecture element with the symbol element. Consequently, before replacing the architecture element with the symbol element, the file-converting method may further include:

(2.a) Selecting the symbol element from the saved architecture element according to the architecture element (Step 105).

Subsequently, the file-converting method can be used to obtain the symbol element from the converting database.

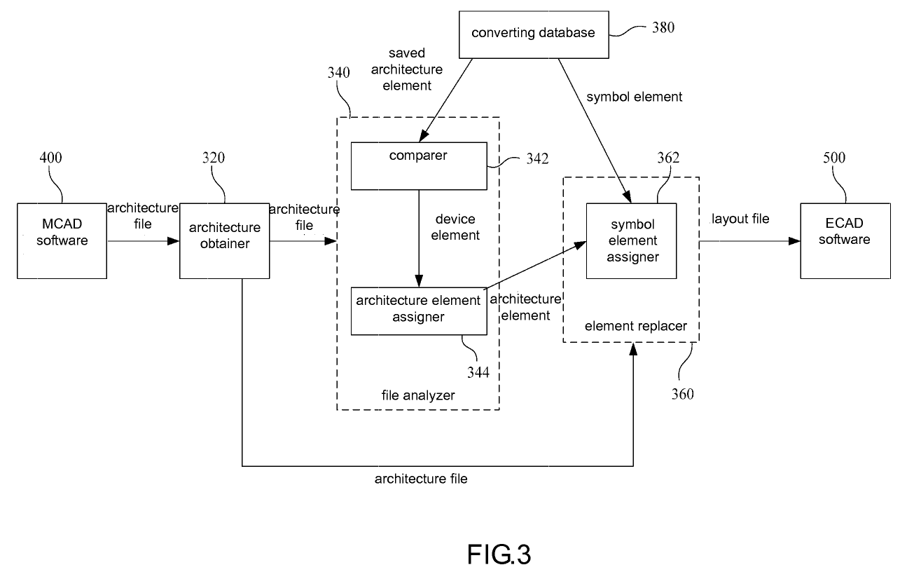

FIG. 3 is a block view showing functions of a file-converting system according to another embodiment of the invention. The file-converting system replaces the architecture element incompatible with the ECAD software with a symbol element, so as to generate a layout file recognizable by the ECAD software. The file-converting system includes an architecture obtainer 320, a file analyzer 340, and an element replacer 360. The architecture obtainer 320 is used to obtain an architecture file from MCAD software 400. The file analyzer 340 is used to analyze the architecture file, so as to obtain at least an architecture element incompatible with ECAD software 500. The element replacer 360 is used to replace the architecture element in the architecture file with a symbol element compatible with the ECAD software 500, to generate a layout file.

The MCAD software 400 may be Pro-E or other types of MCAD software, whereas the ECAD software 500 may be Allegro or other types of ECAD software. The architecture element can be a block, or other elements that cannot be recognized by the ECAD software. For example, the architecture element can be a drill hole element. In other words, the architecture element is a block intended for drilling holes originally. In addition, the architecture element can also be a keepout element. The keepout element is intended for disposing or adhering other architecture elements thereto. In this embodiment of the invention, the architecture file and the layout file can be IDF 3.0, or other file formats that are compatible with the MCAD software and the ECAD software.

Furthermore, the element replacer 360 can further convert element formats of the architecture file that are compatible with the ECAD software 500 into element formats used by the ECAD software 500. Consequently, the file-converting system allows all of the elements of the layout file to be recognized by the ECAD software.

The file-converting system can further employ a database for storing information about elements that are incompatible with the ECAD software 500. Therefore, the file-converting system can further include a converting database 380. The converting database 380 is used for storing at least a saved symbol element thereto, in which the saved symbol element is compatible with the ECAD software 500, and is used to replace a saved architecture element incompatible with the ECAD software 500. Subsequently, the file-converting system can be used to obtain the information about elements that are incompatible with the ECAD software from the converting database.

Additionally, the file analyzer 340 can obtain the architecture element of the architecture file by comparing the information with the saved architecture element in the converting database 380. Thus the file analyzer 340 can further include a comparer 342 and an architecture element assigner 344. The comparer 342 is used for comparing the saved architecture element in the converting database 380 with at least a device element of the architecture file. The architecture element assigner 344 is used for assigning the device element to become the architecture element when the saved architecture element matches with the device element. Hence the file-converting system can obtain the architecture element from the converting database.

Moreover, the file-converting system can obtain the symbol element used for the aforesaid replacement from the converting database 380. Therefore, the element replacer 360 can further include a symbol element assigner 362. The symbol element assigner 362 is used for obtaining the symbol element from the converting database 380 in accordance with the architecture element. The file-converting system can be used to obtain the symbol element for the replacement as a result.

The present invention has been described with preferred embodiments thereof, which is not intended to limit the invention. It is understood that many changes and modifications to the described embodiments can be carried out by anyone skilled in the arts without departing from the scope and the spirit of the invention, which is intended to be limited only by the appended claims.

What is claimed is:

1. A file-converting method, comprising:
obtaining an architecture file from Mechanical Computer-Aided Design (MCAD) software;
analyzing the architecture file to obtain at least an architecture element incompatible with Electrical Computer-Aided Design (ECAD) software, according to a converting database; and
replacing the architecture element in the architecture file with a symbol element compatible with the ECAD software, to generate a layout file.

2. The file-converting method of claim 1, wherein another step precedes the step of analyzing the architecture file, further comprising:
storing at least a saved symbol element to the converting database, wherein the saved symbol element is compatible with the ECAD software, and the saved symbol element is used to replace a saved architecture element incompatible with the ECAD software.

3. The file-converting method of claim 2, wherein the step of analyzing the architecture file comprises:
comparing the saved architecture element with at least a device element of the architecture file; and
assigning the device element to become the architecture element when the saved architecture element matches with the device element.

4. The file-converting method of claim 3, wherein another step precedes the step of replacing the architecture element with the symbol element, further comprising:
selecting the symbol element from the saved architecture element according to the architecture element.

5. The file-converting method of claim 1, wherein the architecture element is a drill hole element.

6. The file-converting method of claim 1, wherein the architecture element is a keepout element.

7. A file-converting system, comprising:
an architecture obtainer for obtaining an architecture file from MCAD software;
a file analyzer for analyzing the architecture file to obtain at least an architecture element incompatible with ECAD software; and
an element replacer for replacing the architecture element in the architecture file with a symbol element compatible with the ECAD software, to generate a layout file.

8. The file-converting system of claim 7, further comprising:
a converting database for storing at least a saved symbol element, wherein the saved symbol element is compatible with the ECAD software, and is used to replace a saved architecture element incompatible with the ECAD software.

9. The file-converting system of claim 8, wherein the file analyzer comprises:
a comparer for comparing the saved architecture element with at least a device element of the architecture file; and
an architecture element assigner for assigning the device element to become the architecture element when the saved architecture element matches with the device element.

10. The file-converting system of claim 8, wherein the element replacer comprises:
a symbol element assigner for selecting the symbol element from the saved symbol element according to the architecture element.

11. The file-converting system of claim 7, wherein the architecture element is a drill hole element.

12. The file-converting system of claim 7, wherein the architecture element is a keepout element.
